(19) United States
(12) Patent Application Publication
(10) Pub. No.: US 2009/0047390 A1
(43) Pub. Date: Feb. 19, 2009

(54) CHICKEN NOODLE BITES

(76) Inventors: John Cassel, Omaha, NE (US); Andrew Draganski, Highland Park, NJ (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 12/180,310

(22) Filed: Jul. 25, 2008

Related U.S. Application Data
(60) Provisional application No. 60/952,470, filed on Jul. 27, 2007.

(51) Int. Cl. A23L 1/315

(52) U.S. Cl. 426/92

(57) ABSTRACT

A snack food incorporating various ingredients of chicken noodle soup is described. The processing of a chicken noodle soup mixture begins with three separate batch operations (e.g., pasta, chicken/vegetable filling, and broth) that are completed before moving to a continuous forming process, such as a triple cold forming extrusion operation. Extrusion typically begins with a machine kneading and then forming a pasta shell under high pressure through a custom die. Concurrently, the chicken/vegetable filling and broth move through the extruder in separate streams allowing for two distinct fillings one inside the other (e.g., broth inside chicken), filling approximately 75% of the pasta shell's volume allowing room for closing. The product is simultaneously cut and sealed at a suitable length.

### CROSS-REFERENCE TO RELATED APPLICATION

The instant application claims priority to U.S. Provisional Patent Application Ser. No. 60/952,470, filed Jul. 27, 2007, the entire specification of which is expressly incorporated herein by reference.

### FIELD OF THE INVENTION

The subject invention generally relates to foodstuffs, and more specifically to a snack food incorporating various ingredients of chicken noodle soup.

### BACKGROUND OF THE INVENTION

Chicken noodle soup has been a popular appetizer and/or meal for several decades and has been touted as a folk remedy for various ailments, including the common cold. Over the years, unhealthy snacking, as opposed to eating healthy snacks and/or meals such as chicken noodle soup, has become a way of life for the average consumer. Unfortunately, this has translated to increasingly abundant ingestion of salty, high fat, and over-processed foods, especially snack foods, which are not especially healthy and which can lead to weight gain, high blood pressure, and coronary artery disease. A primary excuse for these poor eating habits is that it is too much trouble to prepare healthy meals and/or that conventional unhealthy snack foods are more convenient or taste better than healthy snack foods, especially with respect to children's preferences.

Accordingly, there exists a need for a new and improved snack food that overcomes at least one of the aforementioned problems.

### SUMMARY OF THE INVENTION

In accordance with the general teachings of the present invention, new and improved snack foods are provided which are based primarily on the ingredients commonly found in chicken noodle soup, and have been formed into bite-size “chicken noodle bites.”

More specifically, the chicken noodle bites fill the need for hearty, kid-friendly, microwavable frozen snacks targeted at children aged 7-18 by focusing on the classic and favorite flavor of chicken noodle soup, making it unique and convenient while meeting the demands of parents for sensible, nutritious snacking options for their children. The chicken noodle bites provide a healthy, convenient, appealing snack option to kids, which are also delicious and microwavable.

Through advanced processing technology and careful ingredient formulation, a microwaveable snack has been designed that combines all of the textures of chicken noodle soup. For example, a pasta shell shaped like a soup can is stuffed with a ground chicken and vegetable mixture. Inside of this filling resides an amount of a thick, flavorful broth or broth-like material (e.g., soup, potage, gumbo, consommé, bouillabaisse, bisque, chowder and/or the like). The chicken noodle bites utilize lean ground chicken, fresh vegetables, nutritious thick broth, and whole grain pasta to yield an optimized nutritional profile of high fiber and protein, low fat, and supplemented with Omega-3 fatty acids; all accomplished with no sacrifice of flavor or appeal. This unique product can be conveniently packaged individually in disposable microwavable trays of several piece servings. It should be appreciated that various meats (e.g., beef, pork, lamb, and/or the like), poultry (e.g., turkey, goose, duck, and/or the like), fish, seafood (e.g., shrimp, crab, lobster, oysters, mussels, clams, and/or the like), or other protein sources (e.g., soy, bean curd, and/or the like) can be substituted for the chicken ingredient. Additionally, the vegetable and/or broth ingredients can be varied to appeal to different consumer taste preferences.

In accordance with a first embodiment of the present invention, a microwavable foodstuff is provided, comprising: (1) a pasta shell having at least one open end; (2) a mixture of a high protein foodstuff and vegetable foodstuff disposed through the at least one open end within an interior space of the pasta shell; and (3) a broth foodstuff disposed through the at least one open end within and substantially enveloped by the mixture of the high protein foodstuff and vegetable foodstuff.

In accordance with a second embodiment of the present invention, a microwavable foodstuff is provided, comprising: (1) a pasta shell having at least one open end; (2) a mixture of a high protein foodstuff and vegetable foodstuff disposed through the at least one open end within an interior space of the pasta shell; (3) a broth foodstuff disposed through the at least one open end within and substantially enveloped by the mixture of the high protein foodstuff and vegetable foodstuff; and (4) a hydrocolloid incorporated into any of the mixture of a high protein foodstuff and vegetable foodstuff or the broth foodstuff.

In accordance with a third embodiment of the present invention, a microwavable foodstuff is provided, comprising: (1) a pasta shell having at least one open end; (2) a mixture of a high protein foodstuff and vegetable foodstuff disposed through the at least one open end within an interior space of the pasta shell, wherein the high protein foodstuff comprises a material selected from the group consisting of beef, pork, lamb, chicken, turkey, goose, duck, fish, shrimp, crab, lobster, oysters, mussels, clams, soy, bean curd, and combinations thereof, wherein the vegetable foodstuff comprises a material selected from the group consisting of celery, carrot, onion, and combinations thereof; (3) a broth foodstuff disposed through the at least one open end within and substantially enveloped by the mixture of the high protein foodstuff and vegetable foodstuff, wherein the broth foodstuff comprises a material selected from the group consisting of broth, soup, potage, gumbo, consommé, bouillabaisse, bisque, chowder, and combinations thereof; and (4) a hydrocolloid incorporated into any of the mixture of a high protein foodstuff and vegetable foodstuff or the broth foodstuff, wherein the hydrocolloid comprises a material selected from the group consisting of agar, alginate, arabinoxylan, carrageenan, carboxymethyl cellulose, cellulose, curdian, gelatin, gellan, β-glucan, guar gum, gum arabic, hydroxypropyl methylcellulose, locust bean gum, pectin, starch, xanthan gum, and combinations thereof.

Further areas of applicability of the present invention will become apparent from the detailed description provided hereinafter. It should be understood that the detailed description and specific examples, while indicating the preferred embodiment of the invention, are intended for purposed of illustration only and are not intended to limit the scope of the invention.

### BRIEF DESCRIPTION OF THE DRAWINGS

The present invention will become more fully understood from the detailed description and the accompanying drawings, wherein:

FIG. 1 illustrates a schematic view of an exemplary preparation method for manufacturing a snack food in accordance with the general teachings of the present invention; and

FIG. 2 illustrates a perspective view of several pieces of a snack food produced in accordance with the general teachings of the present invention.

### DETAILED DESCRIPTION OF THE INVENTION

The following description of the preferred embodiment(s) is merely exemplary in nature and is in no way intended to limit the invention, or uses.

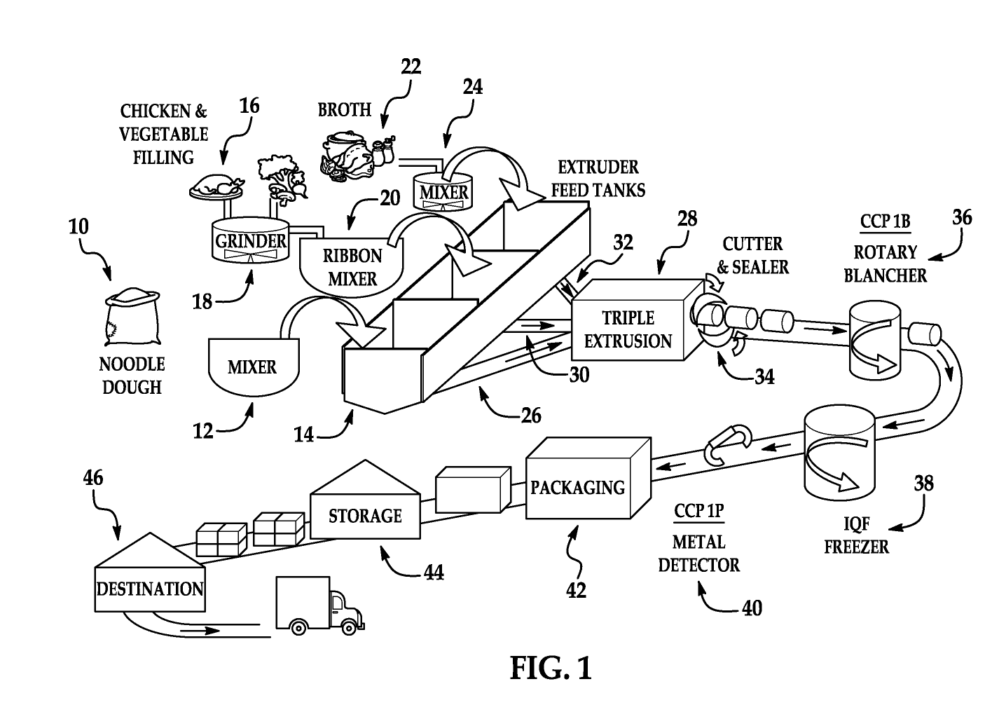

By way of a non-limiting example, and referring to FIG. 1, the processing of a chicken noodle soup mixture begins with three separate batch operations (e.g., pasta (e.g., a flour, water and/or egg based dough food product), chicken/vegetable filling, and broth) that should be completed before moving to a forming process, e.g., such as but not limited to a continuous triple cold forming extrusion operation.

As that term is used herein, “pasta,” shall be considered to be synonymous to any flour, water and/or egg based dough food product.

As that phrase is used herein, “chicken/vegetable filling,” shall be considered to be synonymous to any mixture of any relatively high protein foodstuff and any vegetable foodstuff.

As that phrase is used herein, “relatively high protein foodstuff,” shall be considered to be synonymous to any meats (e.g., beef, pork, lamb, and/or the like), poultry (e.g., turkey, goose, duck, and/or the like), fish, seafood (e.g., shrimp, crab, lobster, oysters, mussels, clams, and/or the like), or other protein sources (e.g., soy, bean curd, and/or the like).

As that phrase is used herein, “vegetable foodstuff,” shall be considered to be synonymous to any vegetable including but not limited to celery, carrot, onion, and/or the like.

As that term is used herein, the term “broth,” shall be considered to be synonymous to any relatively thick and/or flavorful broth-like material, including but not limited to a soup, potage, gumbo, consommé, bouillabaisse, bisque, chowder and/or the like.

With respect to the pasta preparation, suitable dry ingredients 10 are metered and added to a ribbon mixer 12 or other suitable device to homogenize, and then water, preferably filtered or purified water, is incorporated therein. The finished dough is moved via a transport device, e.g., a trolley, and deposited in a forming device, e.g., an extrusion feed tank 14.

In accordance with a non-limiting example, making a consistent, high quality, extrudable pasta dough is important to the process. Consistently sized flour particles should be evenly hydrated by a balanced amount of water to develop a continuous gluten network in the dough. A specified blend of flour or flour-related products, e.g., durum semolina, whole wheat flour, and vital wheat gluten, is delivered, e.g., via truck, and deposited in a suitably large receptacle, e.g., an indoor silo. Emptying of the silo is achieved, e.g., pneumatically, via a spiral feeder to a conical style vertical screw blender whereupon the remaining dry ingredients (e.g., salt, crumb softener, and dried egg white), are manually added to the blender and mixing is completed in an appropriate time, e.g., 5 minutes. The contents are deposited directly below into the weigh hopper of a loss-in-weight feeder which feeds a controlled amount of flour and approximately 40 degree Celsius water into a high speed mixer. Both feeds are controlled by computer to provide a consistent ratio of water and flour to yield a flowing, wetted flour mixture at approximately 31% moisture content. This loose, wet mix now enters a vacuum screw, where air is removed from the dough to protect against color degradation from enzymatic activity and oxidative decomposition. This feeds directly into a co-rotating screw extruder, which intermixes and kneads the dough to create a protein framework. In the final zone, the screw flights narrow to generate enough pressure on the dough to press it through the die. The barrel is jacketed with cooling water to eliminate heat generated in pressurization; this keeps the dough below approximately 55 degrees Celsius (where the proteins begin to irreversibly denature).

With respect to the chicken/vegetable filling preparation 16, thawed chicken (e.g., 60% breast/40% thigh) is ground with cleaned fresh vegetables (e.g., celery, carrot, onion, and/or the like) in a 2:1 ratio through a twin-screw grinder 18 or other suitable device. The ground mixture is then collected in a tank and deposited to the ribbon mixer 20 wherein modified food starch, seasonings, and/or the like are incorporated. The finished mixture is then transported via portable batch tank to its portion of the extrusion feed tank 14.

In accordance with a non-limiting example, skinned, boned, and trimmed to specification chicken breast and thigh meat is received frozen. After overnight thawing under refrigeration, the meat is manually transferred with specified cleaned and sized fresh vegetables (e.g., celery, carrot, onion, and/or the like), to a twin-screw grinder in an approximately 4.4 degree Celsius cold room. The ground mixture is collected in a tank and deposited to a ribbon mixer where modified food starch and seasonings are manually added. The finished batter is tipped to a portable batch tank, which is manually transported to the extrusion feed hopper. A vacuum is applied to remove air from the meat filling for consistent fill-out weight and minimization of lipid oxidation and bacterial action. Finally, it is fed with a positive displacement pump into the triple extrusion die.

With respect to broth preparation 22, suitable dry ingredients are metered and dispersed into a mixing tank 24 at predetermined amounts for mixture with filtered water, under constant agitation by a liquefier. This process maintains proper particle distribution and minimizes any clumping or settling of dry ingredients. The thick broth is now pumped (e.g., via centrifugal pump) to its portion of the feed tank 14 for extrusion.

In accordance with a non-limiting example, dry ingredients are thoroughly mixed in a V-cone tumbling mixer, and then manually dispersed into filtered water in a 50 gallon mixing tank equipped with an anchor-and-gate agitator. This process maintains proper particle distribution and minimizes any clumping or settling. Maximum shear is generated as viscosity greatly increases while a minimal amount of air is entrained. The thick broth is now pumped through a screen via a lobe-type positive displacement pump to the extruder feed tank. The broth is then metered through the die with a diaphragm peristaltic pump.

Extrusion begins with the machine kneading and then forming the pasta shell under high pressure through a custom die 26 to a diameter of approximately 29.2 mm and a thickness of approximately 1.2 mm producing the outer shell. Concurrently, the chicken/vegetable filling and broth move through the extruder 28 in separate streams 30, 32, respectively, allowing for two distinct fillings one inside the other (e.g., broth inside chicken), filling approximately 75% of the pasta shell's volume allowing room for closing. The product is simultaneously cut and sealed (e.g., by a cutting and sealing device 34) at a length of approximately 40.1 mm. In accordance with a non-limiting example, after extrusion, the product is conveyed to a rotary blancher 36 (e.g., for boiling) that is sealed to increase cooking speed and efficiency. As it leaves the blancher 36, pieces are subjected to an air knife that quickly removes surface water and effects significant cooling through evaporative heat loss.

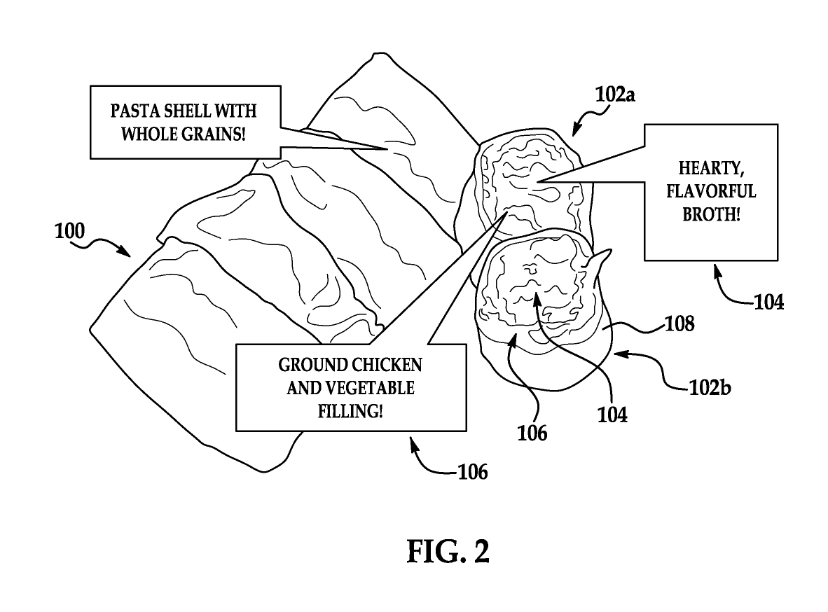

An example of the chicken noodle bite product is shown in FIG. 2. In this view, several whole finished pieces 100 are shown, as well as two cut open pieces 102a, 102b, respectively, that show the relative positions of the broth and meat/vegetable fillings 104, 106, respectively, with respect to one another, as well as the pasta shell 108.

Through proper calibration and design, this system will consistently produce chicken noodle bites containing approximately 5.7 g of pasta, 12.5 g chicken/vegetable, and 3 ml of broth, with minimal waste. Referring again to FIG. 1, the cooking and cooling process will make use of rotary drum technology, cooking the product to a temperature of approximately 70° C. for approximately 2 minutes and rapidly cooling to approximately 4° C. Individual pieces are allowed to drain to remove surface water, and then conveyed into an approximate −20° C. IQF spiral freezer 38. An optional metal detector device 40 can be used to ensure that no metal particles have accidentally been incorporated into the foodstuffs. In an approximate 4° C. cold room, several (e.g., 5) piece portions are placed into a preformed plastic coated paper board tray and enclosed in a LDPE sleeve before placing several (e.g., 4) additional servings into the outer paperboard box, as part of a packaging step 42. Now ready for sale, these boxes are further packaged into corrugated distribution boxes, palleted, and are moved to a frozen storage facility 44 before the distribution step 46. Although this product can be produced using triple feed cold form extrusion, there could be several other manufacturing methods that could be used as well.

In accordance with a non-limiting example, sensing devices at the outlet point of each stream can report to a computerized operating device, which continually adjusts the flow rates to coincide with each other as well as with the cutting device immediately downstream of the die. A Clean-In-Place (CIP) system allows for wet cleaning of the die, the extrusion screw, and the meat pumping system. This eliminates the need for time-consuming dismantling of the line and removal of the screws. After the system is first flushed with washing water, it is flushed with disinfecting solution to reduce the number of microorganisms. After final water flush, the discharge water is analyzed for presence of microorganisms.

The present invention overcame several significant technological challenges with respect to both the formulation and production of the chicken noodle bites, key among these was achieving and sustaining a palatable broth inside of the meat-vegetable filling. Cold-forming triple extrusion, the solution to the first issue, balances three distinct ingredient submixes. The two fillings will be pumped, one inside of the other, inside of the pasta shell leaving just enough space to allow for pinching of the dough. Keeping the broth inside of, and separate from, the ground chicken mixture was an equally challenging task with potential for moisture migration. Using a combination of hydrocolloids, a balance was found between increased viscosity and palatability that could withstand the rigors of extrusion, cooking, freezing, freeze/thaw cycles, and the blowout potential of microwave reheating. Examples of hydrocolloids useful in the practice of the present invention include, without limitation, agar, alginate, arabinoxylan, carrageenan, carboxymethyl cellulose, cellulose, curdian, gelatin, gellan, β-glucan, guar gum, gum arabic, hydroxypropyl methylcellulose, locust bean gum, pectin, starch, xanthan gum, and/or the like.

To formulate extrudable dough high in fiber and with the requisite tensile strength, a mix of whole durum was used, along with white whole-wheat flour, vital wheat gluten, dough conditioner, and powdered egg whites. White whole-wheat flour provides the added effect of decreased brown color over standard whole-wheat flour. The meat filling is a mixture of chicken, fresh vegetables, and binding agents. To achieve a balance of cost, flavor and fat content, chicken breast and chicken thigh meat were mixed together. Thermally gelling hydroxypropyl methylcellulose is added which activates at approximately 55° C. to prevent blowouts in the microwave. Minimal salt is added for overall flavor enhancement. The broth is a rehydrated dried chicken stock containing freeze/thaw stable hydrocolloids for desired consistency. Modified food starch (e.g., agglomerated/cold water-swelling) provides for most of the viscosity and traditional mouthfeel. Meanwhile, xanthan gum contributes the unique Theological property of pseudoplasticity, which gives high viscosity at low shear rates (e.g., before consumption) for good stabilization properties and to immobilize the liquid over a wide range of temperatures, yet when consumed does not seem thick and heavy in the mouth. Additionally, hydroxypropyl methylcellulose aids in moisture migration management and is stable to freeze/thaw abuse. Flaked freeze dried vegetables are also added to the broth to enhance color and flavor.

By way of a non-limiting example, the nutritional profile of chicken noodle bites can include, without limitation, the following characteristics: (1) low fat (e.g., 3 g or less per reference amount); (2) saturated fat free (e.g., less than 0.5 g saturated fat and less than 0.5 g trans fatty acids per reference amount and per labeled serving); (3) high” “rich in” or “excellent source of” vitamin A (e.g., contains 20% of the Daily Value (DV)); (4) good source of,” “contains,” or “provides” dietary fiber (e.g., 10%-19% of the DV per reference amount); and (5) “an excellent source of” omega-3 EPA and DHA (e.g., 32 mg per serving).

Two consumer sensory tests were conducted, the results of which were helpful in perfecting formulation and marketing strategy. Early in the product development process, a preliminary affective sensory test was conducted with 47 panelists using a 9 point hedonic scale to establish the product's acceptability against a leading frozen snack food, i.e., TOTINO'S™ Pizza Rolls. In all categories (e.g., appearance, aroma, flavor, texture and overall taste), chicken noodle bites scored within 1 point of the TOTINO'S™ Pizza Rolls, showing no statistically significant difference. Over seventy percent of panelists thought that the product produced in accordance with the present invention lived up to the promises made in the concept statement. Next, a consumer focus group was conducted with ten 13-19 year olds, at that time the anticipated target market. While the results where overwhelmingly positive (e.g., including the inability to distinguish between samples with and without omega-3 fatty acids), valuable insight was gained into the frozen snack food market that led to the redefinition of the target market to a broader adult category. The panelists stated that, while they might have a say in what was stocked in their freezer at home, it was their mothers who picked out and purchased the food for the family.

During freezing, water in the chicken noodle bites changes phase from liquid to ice crystals, which lowers the water activity. Shelf life is dramatically increased as deterioration by enzymatic and microbiological activity is effectively halted. Unfortunately, there is potential for physical deterioration associated with frozen food storage, which includes cellular damage due to ice crystal growth and sublimation of surface ice (e.g., freezer burn). These effects are minimized by fast freezing in an IQF tunnel freezer, where rapid nucleation forms numerous uniform ice crystals throughout the product. These small crystals resist large crystal formation and the mechanical damage associated with slow freezing. Despite proper freezing and storage in the processing facility, these conditions will eventually develop during thawing and refreezing in distribution, retail storage, and home use. Thus, to evaluate stability over these freeze/thaw cycles, the chicken noodle bites were subjected to an environmental test chamber and inspected for signs of freezer burn which included external dryness, off-color, and off flavors. From this testing, the estimated maximum allowable storage time was determined to be one year in the warehouse or six months in home freezers.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A microwavable foodstuff, comprising:
a pasta shell having at least one open end;
a mixture of a high protein foodstuff and vegetable foodstuff disposed through the at least one open end within an interior space of the pasta shell; and
a broth foodstuff disposed through the at least one open end within and substantially enveloped by the mixture of the high protein foodstuff and vegetable foodstuff.

2. The invention according to claim 1, further comprising a hydrocolloid incorporated into any of the mixture of a high protein foodstuff and vegetable foodstuff or the broth foodstuff.

3. The invention according to claim 2, wherein the hydrocolloid comprises a material selected from the group consisting of agar, alginate, arabinoxylan, carrageenan, carboxymethyl cellulose, cellulose, curdian, gelatin, gellan, β-glucan, guar gum, gum arabic, hydroxypropyl methylcellulose, locust bean gum, pectin, starch, xanthan gum, and combinations thereof.

4. The invention according to claim 1, wherein the pasta shell is substantially cylindrical.

5. The invention according to claim 1, wherein the pasta shell is extruded.

6. The invention according to claim 1, wherein the high protein foodstuff comprises a material selected from the group consisting of beef, pork, lamb, chicken, turkey, goose, duck, fish, shrimp, crab, lobster, oysters, mussels, clams, soy, bean curd, and combinations thereof.

7. The invention according to claim 1, wherein the vegetable foodstuff comprises a material selected from the group consisting of celery, carrot, onion, and combinations thereof.

8. The invention according to claim 1, wherein the mixture of the high protein foodstuff and the vegetable foodstuff is extruded into the interior space of the pasta shell.

9. The invention according to claim 1, wherein the broth foodstuff comprises a material selected from the group consisting of broth, soup, potage, gumbo, consommé, bouillabaisse, bisque, chowder, and combinations thereof.

10. The invention according to claim 1, wherein the broth foodstuff is extruded into and substantially enveloped by the extruded mixture of the high protein foodstuff and vegetable foodstuff.

11. The invention according to claim 1, wherein the mixture of the high protein foodstuff and vegetable foodstuff is present in a ratio of approximately 2:1.

12. The invention according to claim 1, wherein the mixture of the high protein foodstuff and vegetable foodstuff and the broth foodstuff occupies approximately 75% of an interior volume of the pasta shell.

13. The invention according to claim 1, wherein the at least one open end of the pasta shell is closed after the high protein foodstuff and vegetable foodstuff and the broth foodstuff has been disposed within the interior space of the pasta shell.

14. The invention according to claim 1, wherein the pasta shell, the mixture of the high protein foodstuff and vegetable foodstuff, and the broth foodstuff are present in a weight ratio of approximately 2:4:1.

15. A microwavable foodstuff, comprising:
a pasta shell having at least one open end;
a mixture of a high protein foodstuff and vegetable foodstuff disposed through the at least one open end within an interior space of the pasta shell;
a broth foodstuff disposed through the at least one open end within and substantially enveloped by the mixture of the high protein foodstuff and vegetable foodstuff; and
a hydrocolloid incorporated into any of the mixture of a high protein foodstuff and vegetable foodstuff or the broth foodstuff.

16. The invention according to claim 15, wherein the hydrocolloid comprises a material selected from the group consisting of agar, alginate, arabinoxylan, carrageenan, carboxymethyl cellulose, cellulose, curdian, gelatin, gellan, β-glucan, guar gum, gum arabic, hydroxypropyl methylcellulose, locust bean gum, pectin, starch, xanthan gum, and combinations thereof.

17. The invention according to claim 15, wherein the pasta shell is substantially cylindrical.

18. The invention according to claim 15, wherein the pasta shell is extruded.

19. The invention according to claim 15, wherein the high protein foodstuff comprises a material selected from the group consisting of beef, pork, lamb, chicken, turkey, goose, duck, fish, shrimp, crab, lobster, oysters, mussels, clams, soy, bean curd, and combinations thereof.

20. The invention according to claim 15, wherein the vegetable foodstuff comprises a material selected from the group consisting of celery, carrot, onion, and combinations thereof.

21. The invention according to claim 15, wherein the mixture of the high protein foodstuff and the vegetable foodstuff is extruded into the interior space of the pasta shell.

22. The invention according to claim 15, wherein the broth foodstuff comprises a material selected from the group consisting of broth, soup, potage, gumbo, consommé, bouillabaisse, bisque, chowder, and combinations thereof.

23. The invention according to claim 15, wherein the broth foodstuff is extruded into and substantially enveloped by the extruded mixture of the high protein foodstuff and vegetable foodstuff.

24. The invention according to claim 15, wherein the mixture of the high protein foodstuff and vegetable foodstuff is present in a ratio of approximately 2:1.

25. The invention according to claim 15, wherein the mixture of the high protein foodstuff and vegetable foodstuff and the broth foodstuff occupies approximately 75% of an interior volume of the pasta shell.

26. The invention according to claim 15, wherein the at least one open end of the pasta shell is closed after the high protein foodstuff and vegetable foodstuff and the broth foodstuff has been disposed within the interior space of the pasta shell.

27. The invention according to claim 15, wherein the pasta shell, the mixture of the high protein foodstuff and vegetable foodstuff, and the broth foodstuff are present in a weight ratio of approximately 2:4:1.

28. A microwavable foodstuff, comprising:
a pasta shell having at least one open end;
a mixture of a high protein foodstuff and vegetable foodstuff disposed through the at least one open end within an interior space of the pasta shell;
wherein the high protein foodstuff comprises a material selected from the group consisting of beef, pork, lamb, chicken, turkey, goose, duck, fish, shrimp, crab, lobster, oysters, mussels, clams, soy, bean curd, and combinations thereof;
wherein the vegetable foodstuff comprises a material selected from the group consisting of celery, carrot, onion, and combinations thereof;
a broth foodstuff disposed through the at least one open end within and substantially enveloped by the mixture of the high protein foodstuff and vegetable foodstuff;
wherein the broth foodstuff comprises a material selected from the group consisting of broth, soup, potage, gumbo, consommé, bouillabaisse, bisque, chowder, and combinations thereof; and
a hydrocolloid incorporated into any of the mixture of a high protein foodstuff and vegetable foodstuff or the broth foodstuff;
wherein the hydrocolloid comprises a material selected from the group consisting of agar, alginate, arabinoxylan, carrageenan, carboxymethyl cellulose, cellulose, curdian, gelatin, gellan, O-glucan, guar gum, gum arabic, hydroxypropyl methylcellulose, locust bean gum, pectin, starch, xanthan gum, and combinations thereof.

29. The invention according to claim 28, wherein the pasta shell is substantially cylindrical.

30. The invention according to claim 28, wherein the pasta shell is extruded.

31. The invention according to claim 28, wherein the mixture of the high protein foodstuff and the vegetable foodstuff is extruded into the interior space of the pasta shell.

32. The invention according to claim 28, wherein the broth foodstuff is extruded into and substantially enveloped by the extruded mixture of the high protein foodstuff and vegetable foodstuff.

33. The invention according to claim 28, wherein the mixture of the high protein foodstuff and vegetable foodstuff is present in a ratio of approximately 2:1.

34. The invention according to claim 28, wherein the mixture of the high protein foodstuff and vegetable foodstuff and the broth foodstuff occupies approximately 75% of an interior volume of the pasta shell.

35. The invention according to claim 28, wherein the at least one open end of the pasta shell is closed after the high protein foodstuff and vegetable foodstuff and the broth foodstuff has been disposed within the interior space of the pasta shell.

36. The invention according to claim 28, wherein the pasta shell, the mixture of the high protein foodstuff and vegetable foodstuff, and the broth foodstuff are present in a weight ratio of approximately 2:4:1.
